(19) United States
(12) Patent Application Publication
(10) Pub. No.: US 2005/0285027 A1
(43) Pub. Date: Dec. 29, 2005

(54) Scanning optical devices and systems

(75) Inventors: Gregg Ethan Favalora, Arlington, MA (US); Won Chun, Cambridge, MA (US); Oliver Strider Cossairt, Cambridge, MA (US); Rick K. Dorval, Goffstown, NH (US); Michael Halle, Cambridge, MA (US); Joshua Napoli, Arlington, MA (US); Michael Thomas, Belmont, MA (US)

Correspondence Address: FISH & RICHARDSON PC, P.O. BOX 1022, MINNEAPOLIS, MN, 55440-1022, US

(73) Assignee: Actuality Systems, Inc., Burlington, MA (US)

(21) Appl. No.: 11/058,016

(22) Filed: Feb. 15, 2005

Related U.S. Application Data
(60) Provisional application No. 60/555,602, filed on Mar. 23, 2004.

(51) Int. Cl. H01J 3/14

(52) U.S. Cl. 250/234

(57) ABSTRACT

In general, in one aspect, the invention features an optical system which forms a light field by providing components of the light field in a series of frames to an image space. The optical system includes a spatial light modulator, a projection lens assembly configured to image the spatial light modulator to the image space for each of a plurality of optical paths, and a scanning optical component configured to direct light from the spatial light modulator through the projection lens to the image space, wherein during operation the scanning optical component directs light corresponding to successive frames along each of the plurality of optical paths through the projection lens assembly.

### CROSS-REFERENCE TO RELATED APPLICATIONS

This application claims priority under 35 USC §119 to Provisional Patent Application No. 60/555,602, entitled “SCANNED MULTIVIEW THREE-DIMENSIONAL DISPLAY,” filed on Mar. 23, 2004, the entire contents of which are hereby incorporated by reference.

### FEDERALLY SPONSORED RESEARCH OR DEVELOPMENT

The U.S. Government may have certain rights in this invention pursuant to Grant No. 70NANB3H3028 awarded by the National Institute of Standards and Technology (NIST).

### TECHNICAL FIELD

This invention relates to scanning optical devices and systems, and more particularly to scanning multiview three-dimensional displays.

### BACKGROUND

Three-dimensional displays create images that provide one or more stereoscopic depth cues to an observer, such as motion parallax and the ability to elicit an accommodation (focusing) response in the eye. A variety of three-dimensional display methodologies have been developed, including projecting patterns of light onto a moving or spinning surface, gating the transparency of shuttered glasses while gazing at alternating left- and right-eye viewpoints, or using an acousto-optic modulator to diffract laser light and then raster-scanning that light over an image plane.

### SUMMARY

In general, in one aspect, the invention features an optical system which forms a light field by providing components of the light field in a series of frames to an image space. The optical system includes a spatial light modulator, a projection lens assembly configured to image the spatial light modulator to the image space for each of a plurality of optical paths, and a scanning optical component configured to direct light from the spatial light modulator through the projection lens to the image space, wherein during operation the scanning optical component directs light corresponding to successive frames along each of the plurality of optical paths through the projection lens assembly.

In general, in a further aspect, the invention features an optical system which forms a three-dimensional image by providing components of the three-dimensional image in a series of frames to an image space. The optical system includes a spatial light modulator, a projection lens assembly configured to image the spatial light modulator to the image space for each of a plurality of optical paths, and a scanning optical component configured to direct light from the spatial light modulator through the projection lens to the image space, wherein during operation the scanning optical component directs light corresponding to successive frames along each of the plurality of optical paths through the projection lens assembly.

In general, in another aspect, the invention features an optical system which forms a light field by providing components of the light field in a series of frames to an image space where the optical system includes a spatial light modulator, a diffusing screen positioned in the image space, and a scanning optical component configured to direct light from the spatial light modulator to the image space, wherein during operation the scanning optical component directs light corresponding to successive frames along different optical paths in a horizontal plane to the diffusing screen and the diffusing screen scatters incident light in a vertical direction.

In general, in a further aspect, the invention features an optical system which forms a light field by providing components of the light field in a series of frames to an image space where the optical system includes a spatial light modulator, a projection lens assembly comprising an aspheric lens, and a scanning optical component configured to direct light from the spatial light modulator through the projection lens assembly to the image space, wherein during operation the scanning optical component directs light corresponding to successive frames along different optical paths through the projection lens assembly to form the light field at the image space. The projection lens assembly can image the spatial light modulator to the image space for each of the different optical paths.

In general, in a further aspect, the invention features an optical system which forms a light field by providing components of the light field in a series of frames to a primary image space where the optical system includes a spatial light modulator which is imaged by the optical system to an intermediate image space, a projection lens assembly configured to image the spatial light modulator to the primary image space, and a scanning optical component coincident with the intermediate image space and configured to direct light from the spatial light modulator through the projection lens, wherein during operation the scanning optical component directs light corresponding to successive frames along different paths through the projection lens assembly.

Embodiments of the optical systems can include one or more of the following features. The different optical paths can correspond to different orientations of the scanning optical component with respect to the spatial light modulator. The light field can correspond to a three-dimensional image.

The optical systems can include an optical relay which images the spatial light modulator to an intermediate image surface. The scanning optical component can be coincident with the intermediate image surface. The scanning optical component can be located at a pupil of the projection lens assembly. The scanning optical component can be a reflective scanning optical component or a transmissive scanning optical component. The scanning optical component can include at least two scanners configured to scan in orthogonal directions. The scanning optical component can include a mirror mounted on a galvanometer.

The projection lens assembly can include a plurality of lenses. The projection lens assembly can include one or more aspheric lenses.

The optical systems can include a spatial filter configured to filter light from the spatial light modulator prior to the optical scanning directing the light to the projection lens. In some embodiments, the optical systems can include a diffusing screen located at the image space. The scanning optic can scan the light along different paths in a horizontal plane and the diffusing screen scatters incident light in a vertical direction.

The spatial light modulator can be a zero-dimensional spatial light modulator. The spatial light modulator can be a one-dimensional spatial light modulator. The spatial light modulator can be a two-dimensional spatial light modulator. The spatial light modulator can be an emissive spatial light modulator. The spatial light modulator can be a reflective spatial light modulator. The spatial light modulator can be a micro electromechanical device.

The optical systems can include a light source configured to direct light to reflect from the spatial light modulator. The light source can be a laser.

Embodiments of the invention can include one or more of the following advantages. In some embodiments, three-dimensional displays can produce images having relatively high resolution. For example, optical scanners used to generate three-dimensional images can include high-resolution, high-speed spatial light modulators (SLMs) (e.g., the Digital Micromirror Device™ (DMD™) from Texas Instruments (Piano, Tex.)). The SLMs, in conjunction with one or more scanning components, can provide a large number of high-resolution component image frames in a three-dimensional image.

In certain embodiments, three-dimensional displays can produce images having relatively large viewing angles. For example, optical scanners are used to generate light fields corresponding to three-dimensional images that diverge over a wide range of angles in a horizontal viewing range. Accordingly, images can be viewed over a relatively large range of positions in the horizontal viewing plane. Alternatively, or additionally, optical scanners used to generate three-dimensional images can diffuse light into a wide range of angles in a vertical viewing direction. Accordingly, in certain embodiments, three-dimensional images generated by optical scanners can be viewed from positions over a relatively wide angular range in both the horizontal and vertical viewing directions.

Optical scanners can be made using commercially available optical components. For example, optical scanners can include a commercially available light source (e.g., a commercially available laser), a commercially available spatial light modulator (SLM) (e.g., a two dimensional SLM, such as a DMD™, or a liquid crystal display), and/or one or more commercially available optical components (e.g., lenses, iris, mirrors, diffusing screens). Accordingly, optical scanners can be economically manufactured relative to systems that use custom-made components.

Furthermore, systems disclosed herein can utilize commercially available video processing hardware to create a three-dimensional frame database for generating drive signals for the system. As an example, in some embodiments, commercially available video cameras and/or personal computers can be used to acquire images of an object, to process the images to render frame data, and to store the frame data before uploading the data to the projector. Accordingly, optical scanners and systems for providing image data for optical scanners can be relatively inexpensive.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is an isometric view of an optical scanner.

FIG. 2 is a top view of components of the optical scanner shown in FIG. 1 at a time, t₁.

FIG. 3 is a top view of the components of the optical scanner shown in FIG. 2 at a later time, t₂. FIG. 4 is a top view of the components of the optical scanner shown in FIG. 2 at a later time, t₃.

FIG. 5 is a side view of components of the optical scanner, showing rays at t₁, t₂, and t₃.

FIG. 6 is a top view of a portion of the optical scanner showing a series of rays forming a pixel wavefront.

Like reference symbols in the various drawings indicate like elements.

### DETAILED DESCRIPTION

Embodiments of the invention include optical scanners that can be used to generate variable optical wavefronts at an image surface. In certain embodiments, when integrated over a certain time period, e.g., the integration time of the human visual system, the variable wavefronts correspond to a three-dimensional image.

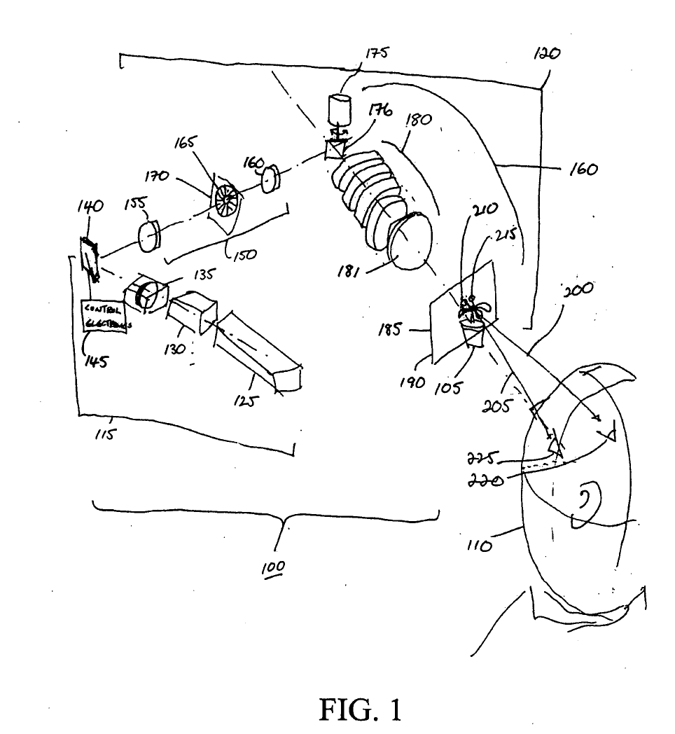

Referring to FIG. 1, an optical scanner 100 includes a projector 115 and relay/scanning optics 120 that present a three-dimensional image 105 to an observer 110. Projector 115 includes a laser 125, a spatial filter 130, a collimator 135, a spatial light modulator (SLM) 140, and an SLM control electronics module 145. Spatial filter 130 includes a pinhole and beam expander that creates a cone of light that propagates towards collimator 135. Collimator 135 creates an approximately cylindrical beam from the cone of light and directs the beam toward SLM 540, which optically modulates the beam based on signals it receives from electronics module 145.

In some embodiments, SLM 140 is a two-dimensional microdisplay operating at about 5,000 frames per second or more with a frame resolution of 1024×768 or more. For example, a Digital Micromirror Device (DMD™), available from Texas Instruments (Piano, Tex.), may be used. A DMD™ includes an array of reflective elements (i.e., pixels). Each element can be oriented in at least two positions, independent of the orientation of the other reflective elements in the array. In one position, the element reflects light from laser 125 towards relay/scanning optics 120, while in the other position the element reflects light in some other direction. Accordingly, the DMD™ modulates the amplitude of a beam from laser 125 in a pixel-wise fashion, based on signals from control electronics 145.

Laser 125 can be one of a variety of lasers, and is typically selected to provide light of a desired wavelength or band of wavelengths. Usually, at least in applications where optical scanner 100 is used to generate a three-dimensional image, the wavelength or wavelengths are in the visible portion of the electromagnetic spectrum (e.g., from about 380 nm to about 780 nm). Laser 125 can be a continuous wave or pulsed laser. As an example, laser 125 can be a green 150 mW diode-pumped solid-state laser, such as a Compass 315M™ laser (available from Coherent, Inc., Santa Clara, Calif.), which has an emission wavelength at 532 nm.

Laser 125 should provide sufficient intensity at the desired wavelength or band of wavelengths for spatial image 105 to be visible in the viewing conditions for which optical scanner 100 is designed. In some embodiments, where laser 125 is a continuous wave laser, the light intensity can be about 10 mW or more (e.g., about 100 mW or more, about 0.5 W or more, about 1 W or more). Laser intensity should not be so high as to damage an observer's eyesight.

In certain embodiments, a phase randomizer, such as a spinning diffuser, may be placed between laser 125 and spatial filter 130. The phase randomizer can reduce coherence effects (e.g., interference effects, such as speckle) associated with the light emitted from laser 125.

Relay/scanning optics 120 modify light modulated by SLM 140 and relay the modified light to light field generating optics 160. Relay/scanning optics 120 includes a one-to-one relay 150 and lightfield-generating optics 160. One-to-one relay 150 includes a first lens 155, an adjustable iris 165 positioned at a Fourier plane of the relay, and a second lens 160. Adjustable iris 165 can be stopped down to pass only a zeroth-order ray of each pixel modulated by SLM 140. This can reduce degradation (e.g., blurring) of spatial image 105 that may otherwise occur if, for example, spatial image 105 is composed of multiple images corresponding to different diffraction orders.

Lightfield-generating optics 160 generates spatial image 105 at image surface 190 by scanning modulated light from projector 115 over a range of different paths through to image surface 190. Lightfield-generating optics 160 includes an oscillating rotary galvanometer (galvo) mirror scanner 175, a scan optics module 180, and a vertical diffuser 185. Galvo mirror scanner 175 includes a mirror 176 that rocks back and forth, e.g., from about −10 degrees to about +10 degrees. In this example, the mirror has a scan amplitude of about 20 degrees and provides a total optical scan of about 40 degrees.

Galvo mirror scanner 175 should scan mirror 176 at a rate that reduces (e.g., eiminates) flicker in the eyes of observer 110. For example, galvo mirror scanner 175 should have a peak-to-peak scan frequency at or above 15 Hz, which corresponds to a scan time of about 1/30 second or less over the scan range. In other words, because galvo mirror scanner 175 covers the scan range twice during a peak-to-peak scan, a scan frequency of about 15 Hz or more will support about a 30 Hz or more image refresh rate, which corresponds to image refresh rates at which flicker is reduced to industry-accepted levels.

In general, the type of waveform used to scan mirror 176 can vary as desired, provided control electronics 145 and SLM 140 are configured to update the beam modulation pattern based on the scanning waveform. In some embodiments, scan mirror 176 is scanned using a triangle waveform, in which the rate of rotation of mirror 176 is constant during a scan. Alternatively, other waveforms, such as sinusoidal waveforms, can be used.

Scan optics module 180 includes five elements that focus light reflected by mirror 176. The elements of scan optics module 180 are chosen so that the light reflected from mirror 176 comes to a vertical focus at the surface of a vertical diffuser 185 and horizontal focus within element 181 of scan optics module 180. In the present embodiment, where scan optics module 180 includes five elements, the first four elements can be spherical lenses, while element 181 is an aspheric lens. The aspheric lens can limit the movement of the vertical focus at image surface 190.

Scan optics module 180 should have an input numerical aperture and aperture stop sufficiently large to accept light reflected from mirror 176 at the extreme positions of galvo mirror scanner 175. Accordingly, in some embodiments, the diameter of the aperture stop for scan optics module 180 is larger than the diameter of the beam relayed from laser 125 to mirror 176 (e.g., about two times larger or more, three times larger or more).

Although scan optics module 180 includes five elements in optical scanner 100, more generally, optical scanners can include fewer than or more than five elements to focus light reflected from mirror 176 in the vertical and horizontal planes. Generally, the elements can be lenses (e.g., spherical or aspheric lenses), reflective elements, such as mirrors (e.g., spherical or aspheric mirrors), and/or diffractive elements.

Vertical diffuser 185 spreads the light vertically with respect to observer 110, allowing the observer to move vertically and still see image 105 from a range of vertical positions. Vertical diffusers can decrease the information and bandwidth requirements of multiview 3-D displays. In some embodiments, vertical diffuser 185 is a 4″×4″ optic with a 0.2-degree horizontal diffusion and 30 degree vertical diffusion, as made by Physical Optics Corporation (Torrance, Calif.).

In general, display 100 can include standard, commercially available components and/or custom made components. For example, one or more of the passive components (e.g., lenses, iris, diffuser, mirror) can be obtained commercially. Furthermore, active components, such as laser 125, SLM 140, and galvo mirror scanner 175 can be obtained commercially. Using commercially available components can reduce the cost of optical scanner 1100, providing an economic advantage to the manufacturer.

Optical scanner 100 constructs image 105 by directing light from laser 125 along a number of different ray paths through image surface 190 such that the light forms an approximation of a wavefront that would emanate towards observer 110 from a surface of a three-dimensional scene located at image surface 190. SLM 140 modulates the cross-sectional profile of the light beam from laser 125 as galvo mirror scanner 175 scans mirror 176 so that the light field at image surface 190 integrated over a single excursion of mirror 176 corresponds to a three-dimensional image wavefront. The wavefronts are synthesized in a time-division-multiplexed manner. In other words, at any instant only a subset of the rays forming the wavefront emanate through image surface 190. However, the image looks complete to observer 110 when summed over the integration period of observer 110's eye (e.g., about 1/30 second).

Control electronics 145 and the frame data driving SLM 140 should account for the time-varying relationship between the drive command of galvo mirror scanner 175, and the actual orientation of mirror 176 with respect to SLM 140 so that appropriate frames are directed to mirror 176 when it is properly oriented to generate the appropriate light field at image surface 190.

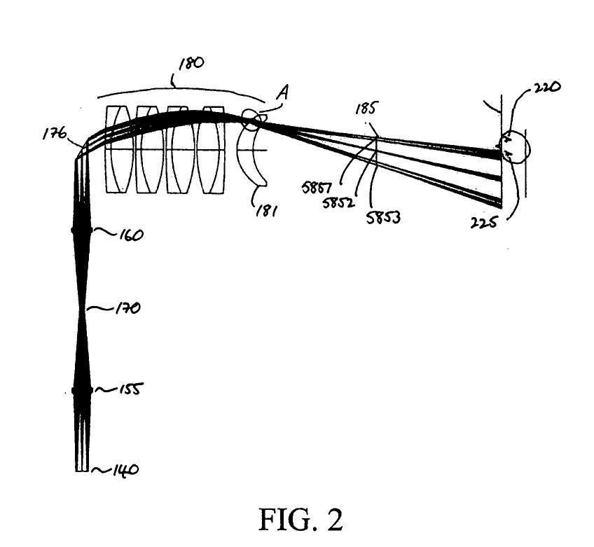

The light field corresponding to a three-dimensional image is composed of a number of “pencils,” which is a group of light rays corresponding to a single SLM frame. The rays in a pencil propagate from a horizontal focal point, e.g., within element 181 of scanning optics module 180. Each pencil is composed of one or more “viewlets.” In FIG. 1, a first viewlet 200 emanates from location 210 in image surface 190 an is observed by observer 110's right eye 220. Similarly, a second viewlet 205 emanates from location 215 in image surface 190 and is observerd by observer 110's left eye 225. A viewlet corresponds to a light ray from one pixel of SLM 140 reflected from mirror 176 at one instant during the scan. Accordingly, each pixel of SLM 140 can contribute to multiple viewlets as galvo mirror scanner 175 scans mirror 176. This process is described with reference to FIGS. 2-5 below.

Referring to FIG. 2, once a first modulation pattern is loaded into SLM 140, SLM 140 reflects a beam having a spatially-modulated profile to scanning mirror 175. At the instant in time corresponding to when the first modulation pattern is loaded into SLM 140, t₁, scanning mirror reflects each portion of the modulated beam along a particular set of paths through scanning optics 580. Scanning optics 580 focus the beam to a location, A, within the aspheric lens in the scanning optics. The beam emerges from A as a number of viewlets, which are diffused by vertical diffuser 185 at image plane 180 prior to reaching observer 110 at an observing plane. Certain viewlets enter one or both of the observer's eyes depending on the observer's position and the content of the three-dimensional image.

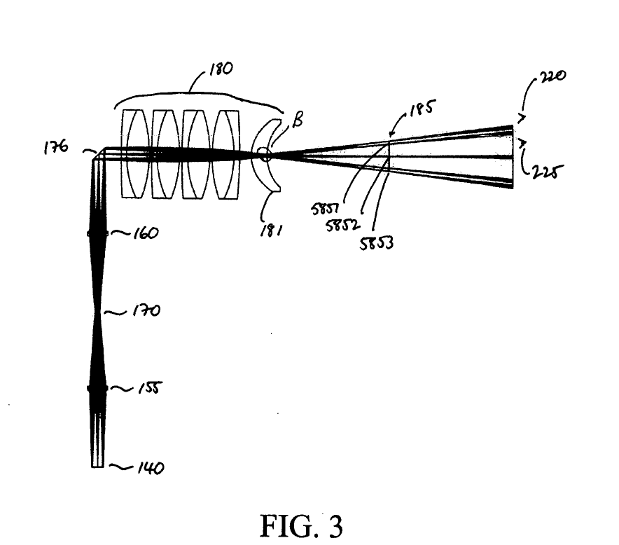

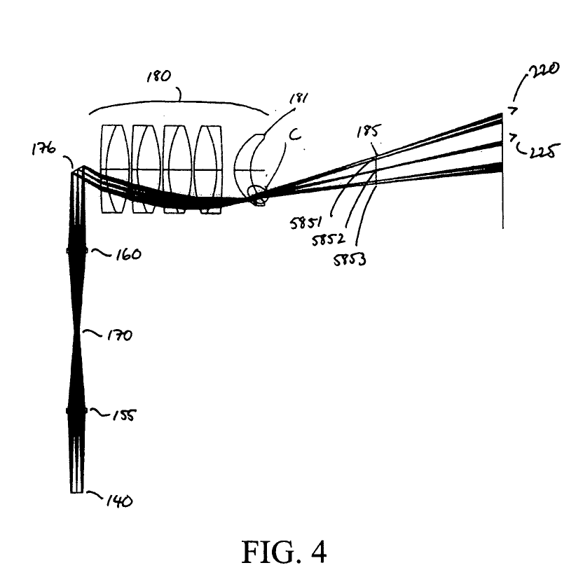

Referring to FIG. 3, at a later time, t₂, a new modulation pattern is loaded into SLM 140, and mirror 176 advances to a different orientation with respect to SLM 140. At this time, optical scanner 100 generates a different set of viewlets by directing portions of the modulated beam along a different set of paths through scanning optics 580, which focus the beam to a point B in aspheric lens 181, and a pencil of viewlets fans out from point B. Each viewlet intersects vertical diffuser 185 at regions 5851, 5852, and 5853, but with a different set of directions for each region in the diffuser plane. Again, viewlets enter one or both of the observer's eyes depending on the observer's position and the content of the three-dimensional image.

Referring to FIG. 4, at a still later time, t₃, scanning mirror 175 has rotated to its greatest angular excursion, moving the apex of the pencil of viewlets to position C in aspheric lens 181. As for the configurations described previously, viewlets pass through regions 5851, 5852, and 5853 in image surface 190 with a different set of directions relative to image surface 190, and enter one or both of observer 110's eyes at the observer's position.

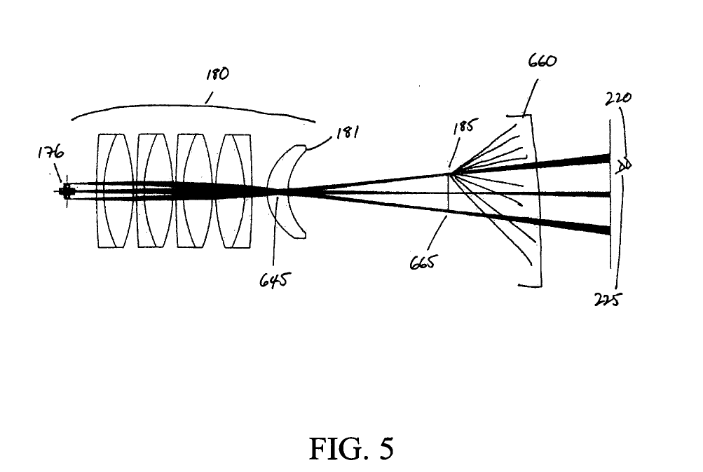

Referring to FIG. 5, at times t₁, t₂, and t₃, scanning optics module 180 has a vertical focus at a position 665, at which diffuser 185 is positioned, and a horizontal focus at location 645 in lens 181. Vertical diffuser 185 spreads out incident light into a series of vertical pencils of light, such as vertical pencil 660. The vertical diffusion increases the range of vertical positions from which observer 110 can see the three-dimensional image.

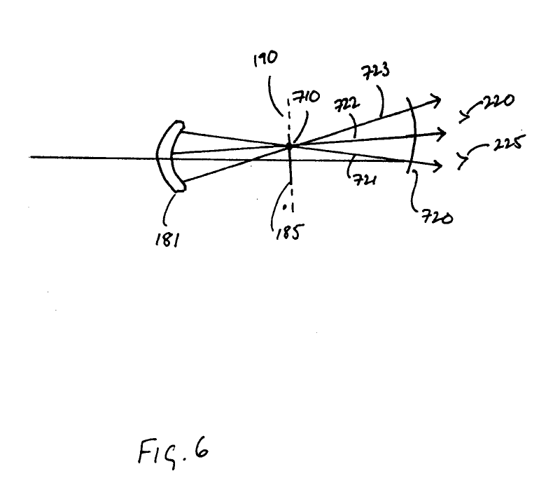

Referring to FIG. 6, a pixel in a three-dimensional scene is perceived from multiple viewlets generated at different times during a scan. For example, viewlets 721, 722, and 723, generated at different times, contribute to a wavefront 720 corresponding to a single pixel 710 of a three-dimensional scene at image surface 190.

As discussed previously, SLM 140 should modulate illumination from laser 125 in an appropriate manner so that optical scanner 100 generates viewlets corresponding to the desired three-dimensional imagery at image surface 190. To achieve appropriate modulation of the laser illumination, control electronics provide drive signals to SLM 140. These drive signals are generated by first acquiring a computational description of the three-dimensional image. From this computational description, an electronic processor determines the amplitudes of one or more viewlets that are projected through one or more portions of image surface 190. In some embodiments, the electronic processor is remote from scanner 100 and control electronics store the image data in local video random access memory.

A computational description of a three-dimensional image for projection using optical scanner 100 can be acquired in a variety of ways. For example, in some embodiments, a database of viewlets can be synthesized by rendering a three-dimensional scene from viewpoints of a computer-graphic camera moving along a linear track. An algorithm for generating frame data from images of an object is described, for example, in U.S. Provisional Patent Application No. 60/560,006, entitled “RENDERING FOR MULTIVIEW/HOLOGRAPHIC VIDEO,” filed on Apr. 5, 2004, the entire contents of which are hereby incorporated by reference.

If the three-dimensional image changes, the viewlets can change for different scans. For a stationary image, however, the modulation pattern is repeated each time the scanning mirror returns to the corresponding orientation.

In general, the resolution of a three-dimensional image generated by optical scanner 100 corresponds to the maximum number of viewlets that can be generated during a scan of mirror 176. This number depends on the resolution of SLM 140 and the frame refresh rate of SLM 140. Generally, the resolution of SLM 140 can vary. In some embodiments, the resolution of SLM 140 corresponds to a standard display mode resolution, such as VGA (640×480), SVGA (800×600), (XGA 1024×768), SXGA (1280×1024), or UXGA (1600×1200).

The frame refresh rate of SLM 140 depends on the type of SLM being used. In some embodiments, for example where SLM 140 is a Micro-Electro-Mechanical System (MEMS) (e.g., a DMD™), the frame refresh rate can be relatively high (e.g., about 100 Hz or more, about 500 Hz or more, about 1,000 Hz or more, about 5,000 Hz or more). The actual frame refresh rate can be the same as or less than the maximum refresh rate for SLM 140.

The viewing angle of optical scanner 100 refers to the range of angles, in both the horizontal and vertical viewing directions, over which image 105 can be viewed. The vertical and horizontal viewing angles can be the same or different. The horizontal viewing angle depends on the range over which mirror 176 is scanned, and on the optical power of scan optics module 180. For example, the larger the range of angles over which mirror 176 is scanned, the larger the horizontal range over which viewlets are directed. In some embodiments, the horizontal viewing angle can be about ±10° or more (e.g., ±12° or more, ±15° or more, ±20° or more). The vertical viewing angle depends on the type of vertical diffuser used at image surface 190. In some embodiments, the vertical viewing angle is about ±10° or more (e.g., ±12° or more, ±15° or more, ±200 or more).

While certain embodiments have been described, it will be understood that various modifications may be made to optical scanner 100 without departing from the spirit and scope of the invention. For example, while optical scanner 100 includes a laser light source, in certain embodiments other light sources can be used. Examples of other light sources include one or more light emitting diodes or arc lamps (e.g., an ultra-high-pressure mercury arc lamp). In general, the light source should provide sufficient intensity at one or more wavelengths to provide a viewable image in lighting conditions for which optical scanner 100 is designed.

Furthermore, while optical scanner includes a specific projector subsystem, other subsystems can also be used. For example, although optical scanner 100 includes a DMD™ as SLM 140, other types of SLM can be used. For example, pixellated Liquid Crystal on Silicon (LCoS) arrays or ferroelectric liquid crystal displays (FELCDs) can be used. Moreover, in some embodiments, instead of a two-dimensional SLM, a scanned device, such as a scanned laser can be used to provide a modulated light field. A scanned laser is an example of a zero-dimension (e.g., point-like) SLM. One-dimensional SLMs, such as a Grating Light Valve (available from Silicon Light Machines™, Sunnyvale, Calif.) can also be used. In general, SLMs can include reflective devices (e.g., DMD™), transmissive devices (e.g., a transmissive LCD), and/or emissive devices (e.g., organic light emitting diode displays).

Furthermore, while optical scanner 100 includes a rotating galvo mirror, in some embodiments the galvo can be replaced by a different scanning element. For example, the glavo can be replaced by a rotating-disc holographic optical element that diffracts light from SLM 140 along different paths to generate viewlets at the observer's position.

In some embodiments, a scanner system can perform a two-dimensional scan across the image plane (e.g., scan in both the horizontal and vertical viewing directions), thereby creating full-parallax imagery. For example, an optical scanner can include two ganged scanning glavo mirrors that are oriented perpendicular to each other. One of the mirrors is scanned horizontally, for example, and the other is scanned vertically.

In certain embodiments, multiple scanners are tiled to provide larger images. For example, several optical scanners can be positioned relative to one another so that their images are seamlessly tiled. By providing appropriate frame data to each scanner, the multi-scanner system can be used to form a single large image.

In some embodiments, tiled systems can share one or more components. For example, multiple systems can use light from a single light source (e.g., by providing a beam splitter between the light source and other components of the systems, a single light source can be used).

The viewing zone can be increased by placing one or more optical elements into the scanner that splits each viewlet into multiple rays. For example, one or more diffractive elements could be incorporated at the location of vertical diffuser 185 or at a location between galvo mirror scanner 175 and vertical diffuser 185.

Although optical scanner 100 generates monochromatic three-dimensional images, in some embodiments optical scanners can be used to generate full color images. As an example, optical scanner 100 can be adapted to include three different light sources, each a different color (e.g., red, green, and blue, or cyan, magenta, and yellow). Light from each source can be modulated using a different SLM. The modulated light can then be combined, for example, prior to incidence on galvo mirror scanner 175. Accordingly, spatial image 105 will then be composed of viewlets of the three different colors.

While in the foregoing discussion optical scanner 100 is used to generate three-dimensional images, in some embodiments, optical scanners can be used for other applications. For example, optical scanners can be used to generate complex wavefronts that can be used in interferometric applications. As an example, complex wavefronts can be used to interferometrically probe complex optical surfaces, such as the surface of an aspheric lens or mirror. This can be achieved, for example, by using an optical scanner to construct a wavefront mimicking a wavefront that would reflect from a complex optical surface if the optical surface is free of defects. This wavefront is then interfered with a wavefront from the actual optical surface. Defects in the optical surface can manifest as variations in the phase of the interferogram across its area. Accordingly, optical scanners can be used in metrology applications.

In some embodiments, optical scanners can be used to generate an object wavefront for a holographic recording. In other words, an optical scanner can replace an object by generating a wavefront mimicking the wavefront that would be formed by illuminating the object with light. This wavefront can be interfered with a reference beam on a recording medium to provide a holographic recording. The reference wavefront can be provided from the same light source as used in the scanner by, for example, splitting the output of the light source and directing a portion of the output directly to the recording medium.

Alternatively, or additionally, to generating complex wavefronts, optical scanners can be used to direct an input beam along one or more different paths. For example, optical scanners can be used in beam steering applications (e.g., for optical communications). Optical scanners can also be used in optical computing applications, for optical interconnections, and/or high-speed optical scanning, for example.

Other embodiments are within the scope of the following claims.

1. An optical system which forms a light field by providing components of the light field in a series of frames to an image space, the optical system comprising:
a spatial light modulator;
a projection lens assembly configured to image the spatial light modulator to the image space for each of a plurality of optical paths; and
a scanning optical component configured to direct light from the spatial light modulator through the projection lens to the image space,
wherein during operation the scanning optical component directs light corresponding to successive frames along each of the plurality of optical paths through the projection lens assembly.

2. The optical system of claim 1, wherein the different optical paths correspond to different orientations of the scanning optical component with respect to the spatial light modulator.

3. The optical system of claim 1, wherein the light field corresponds to a three-dimensional image.

4. The optical system of claim 1, further comprising an optical relay which images the spatial light modulator to an intermediate image surface.

5. The optical system of claim 4, wherein the scanning optical component is coincident with the intermediate image surface.

6. The optical system of claim 4, wherein the scanning optical component is located at a pupil of the projection lens assembly.

7. The optical system of claim 1, wherein the scanning optical component is a reflective scanning optical component.

8. The optical system of claim 1, wherein the scanning optical component is a transmissive scanning optical component.

9. The optical system of claim 1, wherein the scanning optical component comprises at least two scanners configured to scan in orthogonal directions.

10. The optical system of claim 1, wherein the projection lens assembly comprises a plurality of lenses.

11. The optical system of claim 1, wherein the projection lens assembly comprises an aspheric lens.

12. The optical system of claim 1, wherein the scanning optical component comprises a mirror mounted on a galvanometer.

13. The optical system of claim 1, further comprising a spatial filter configured to filter light from the spatial light modulator prior to the optical scanning directing the light to the projection lens.

14. The optical system of claim 1, further comprising a diffusing screen located at the image space.

15. The optical system of claim 14, wherein the scanning optic scans the light along different paths in a horizontal plane and the diffusing screen scatters incident light in a vertical direction.

16. The optical system of claim 1, wherein the spatial light modulator is a zero-dimensional spatial light modulator.

17. The optical system of claim 1, wherein the spatial light modulator is a one-dimensional spatial light modulator.

18. The optical system of claim 1, wherein the spatial light modulator is a two-dimensional spatial light modulator.

19. The optical system of claim 1, wherein the spatial light modulator is an emissive spatial light modulator.

20. The optical system of claim 1, wherein the spatial light modulator is a reflective spatial light modulator.

21. The optical system of claim 20, wherein the spatial light modulator is a micro electromechanical device.

22. The optical system of claim 20, further comprising a light source configured to direct light to reflect from the spatial light modulator.

23. The optical system of claim 22, wherein the light source is a laser.

24. An optical system which forms a three-dimensional image by providing components of the three-dimensional image in a series of frames to an image space, the optical system comprising:
a spatial light modulator;
a projection lens assembly configured to image the spatial light modulator to the image space for each of a plurality of optical paths; and
a scanning optical component configured to direct light from the spatial light modulator through the projection lens to the image space,
wherein during operation the scanning optical component directs light corresponding to successive frames along each of the plurality of optical paths through the projection lens assembly.

25. An optical system which forms a light field by providing components of the light field in a series of frames to an image space, the optical system comprising:
a spatial light modulator;
a diffusing screen positioned in the image space; and
a scanning optical component configured to direct light from the spatial light modulator to the image space,
wherein during operation the scanning optical component directs light corresponding to successive frames along different optical paths in a horizontal plane to the diffusing screen and the diffusing screen scatters incident light in a vertical direction.

26. An optical system which forms a light field by providing components of the light field in a series of frames to an image space, the optical system comprising:
a spatial light modulator;
a projection lens assembly comprising an aspheric lens; and
a scanning optical component configured to direct light from the spatial light modulator through the projection lens assembly to the image space,
wherein during operation the scanning optical component directs light corresponding to successive frames along different optical paths through the projection lens assembly to form the light field at the image space.

27. The optical system of claim 26, wherein the projection lens assembly images the spatial light modulator to the image space for each of the different optical paths.

28. An optical system which forms a light field by providing components of the light field in a series of frames to a primary image space, the optical system comprising:
a spatial light modulator which is imaged by the optical system to an intermediate image space;
a projection lens assembly configured to image the spatial light modulator to the primary image space; and
a scanning optical component coincident with the intermediate image space and configured to direct light from the spatial light modulator through the projection lens,
wherein during operation the scanning optical component directs light corresponding to successive frames along different paths through the projection lens assembly.
